(19) United States
(12) Patent Application Publication
(10) Pub. No.: US 2025/0305520 A1
(43) Pub. Date: Oct. 2, 2025

(54) Bellows Accumulator

(71) Applicant: Hydac Technology GmbH, Sulzbach / Saar (DE)

(72) Inventors: Peter Kloft, Ransbach-Baumbach (DE); Torsten Kusserow, Thörnich (DE); Jens Holger Köhne, Saarbrücken (DE)

(73) Assignee: Hydac Technology GmbH, Sulzbach / Saar (DE)

(21) Appl. No.: 18/699,995

(22) PCT Filed: Nov. 7, 2022
(86) PCT No.: PCT/EP2022/080975

§ 371 Date: Apr. 10, 2024

(30) Foreign Application Priority Data
Nov. 15, 2021 (DE) 10 2021 005 656.6

(51) Int. Cl. F15B 1/10

(52) U.S. Cl. CPC F15B 1/103

(57) ABSTRACT

Disclosed is a bellows accumulator in which a folding bellows, which serves as a movable separating element between a first media side and a second media side, has at its bellows end, a closure body which media-tightly closes of the interior of the folding bellows and, at its other bellows end, is immovably fixed relative to a storage housing. The accumulator has a valve device which, when the pressure on a liquid side drops, moves to a closed position, thereby preventing liquid from continuing to flow out of the storage housing. The closing process for the valve device is controlled using an energy store, which is arranged between the valve device and the closure body of the folding bellows in such a way that a specifiable quantity of liquid remains in the storage housing in any case, the quantity of liquid supporting the folding bellows in an expanded position.

### CROSS-REFERENCE TO RELATED APPLICATIONS

This application claims priority to German Patent Application No. DE 10 2021 005 656.6, filed on Nov. 15, 2021 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to a bellows accumulator, in which a bellows, which serves as a movable separating element between a first media side, in particular a gas side, and a second media side, in particular a liquid side, has, at its bellows end which can move in an axial direction in an accumulator housing during expansion and contraction, a closure body which closes off the interior of the bellows in a media-tight manner, and at its other bellows end is immovably fixed with respect to the accumulator housing, and having a valve device which, when the pressure on the liquid side drops, moves to a closed position, thereby preventing liquid from continuing to flow out of the accumulator housing. The valve device can also move to a closed position if the pre-charge pressure increases due to the ambient temperature.

EP 2 519 748 B1 discloses a hydraulic accumulator configured as a bellows accumulator, in which the bellows, which serves as a movable separating element between gas side and fluid side, has, at its bellows end which can move in an axial direction in the accumulator housing during expansion and contraction, a closure body which closes off the interior of the bellows in a fluid-tight manner and, at its other bellows end, is immovably fixed with respect to the accumulator housing, wherein
a seal arrangement sealing the interior of the bellows at the immovable bellows end with respect to the accumulator housing has, in addition to a first functional region effecting the seal, a second functional region in the form of a shoulder protruding into the interior of the bellows which forms a resilient buffer for the closure body of the bellows to rest on in the fully contracted state,
the bellows provided is a metal bellows with metal closure body welded to the relevant bellows end,
the shoulder protruding into the interior of the bellows has at least one bulge projecting in the axial direction towards the movable bellows end as a resilient buffer for the closure body to rest on,
the immovable bellows end is fixed by means of a fluid-tight weld to a retaining ring attached to the housing, the inner ring opening of which is adjacent to the interior of the bellows which forms the fluid side, and
the seal arrangement with its first functional region forms the seal between the inner ring opening of the retaining ring and the accumulator housing.

In this bellows accumulator, a fluid connection for connecting the same to parts of a hydraulic supply circuit in the accumulator housing is formed by a through connection hole in a connection piece of the accumulator housing, which connection hole is directly controlled by the closure body of the bellows, while opening the said connection hole or shutting off the same. The aforementioned metal bellows accumulator solution may be suitable for use with low pressure differences of a few MPa across the bellows. In contrast, larger pressure differences make themselves felt in a reduced dynamic service life and even total failure of the bellows. In this respect, the bellows accumulator can also not be operated with high pre-load or pre-charge pressures on the gas side.

### SUMMARY

A need exists to provide an improved bellows accumulator solution.

The need is addressed by a bellows accumulator with the features of the independent claim(s). Embodiments of the invention are described in the dependent claims, the following description, and the drawings.

### BRIEF DESCRIPTION OF THE DRAWINGS

FIG. 1 shows an example bellows accumulator as a whole in the manner of a longitudinal section;

FIG. 2 shows an enlarged view of the bottom region of the bellows accumulator according to FIG. 1; and

FIG. 3 shows a view from above of an example ring-like guide body for guiding the bellows in the associated accumulator housing.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

Since, in some embodiments, the closing process for the valve device is controlled by means of at least one energy accumulator, which is arranged between the valve device and the closure body of the bellows, in such a manner that in any case a predefinable quantity of liquid, which supports the bellows in its expanded position, remains in the accumulator housing, it is possible to operate the bellows accumulator with high pre-charge pressures on its first media side or gas side, as the bellows can be supported in any case on the liquid side of the accumulator housing, even if the valve device is completely closed. In this way, the bellows can safely handle even major pressure differences during operation of the bellows accumulator, i.e., a long service life is guaranteed even in dynamic operation and failure of the bellows, for example due to tearing at the bellows folds, is prevented. When the valve device is opened, routinely by opening a valve disc, no permanent pressure transmission takes place.

The bellows accumulator requires only a single passage opening on the liquid side of the accumulator housing, the inserted valve device controlling both the inlet and outlet into said liquid side with the (hydraulic) fluid, the energy accumulator introduced between this valve device and the closure body of the bellows, routinely in the form of a compression spring, enabling the bellows to be permanently supported on the liquid side during its expansion movement as part of increasingly dynamic damping, in particular also by throttling the media or liquid flow by means of the valve device, and with the support effect becoming stronger as the valve device closes, until the accumulator housing is completely emptied of the support fluid on its liquid side, except for a predefinable residual quantity. In this way, it is provided that even when the valve device in the accumulator housing is closed, a residual amount of liquid remains enclosed in the accumulator housing, against which the bellows can support itself on its inner side under the action of the pre-charge gas pressure.

In the reverse case, i.e., when the valve device is opened, in which a fluid-conducting connection to the connected hydraulic circuit is visibly established on the liquid supply side of the accumulator until the fully open passage position is reached, the valve device is opened in such a way that load is transferred gently to the bellows.

In some embodiments, it is provided that the valve device has a poppet valve, the valve disc of which is held in its open position, allowing liquid through, counter to the action of a further energy accumulator and, when actuated, moves into its closed position, blocking the passage of liquid. If the valve disc is pressurised on both sides with liquid at a predefinable pressure, the valve disc acts with its surface against the pressure of the liquid remaining in the accumulator (corresponding to the gas-side pre-charge pressure) and the spring force of the end part of the metal bellows. There is therefore no appreciable pressure transmission. As the plate-shaped end part of the metal bellows does not sit directly on the valve disc, there is no pressure transmission to any of the different surfaces of the valve disc and end plate. The aforementioned additional energy accumulator is for example formed by a compression spring. From a theoretical point of view, a kind of double-mass oscillator is formed with the two individual masses in the form of the bellows and the poppet valve, each of which rests at opposite ends on an energy accumulator or a spring which can accelerate but also damp the movement of the masses. In this case, a spring is formed by the pre-charge pressure on the gas side of the bellows which is primarily supported by the fluid. This valve disc is supported in turn on the opposing side, directed away, by the further energy accumulator in the form of the further compression spring. In this case, this compression spring engages with its one end with the underside of the valve disc of the poppet valve and is held stationary in parts of the accumulator housing with its other end.

If liquid now flows under pressure from the hydraulic circuit to the liquid side of the accumulator housing, the poppet valve opens appreciably and at the same time is supported in the opening movement by the second compression spring as a poppet valve spring, the aforementioned opening process of the valve device being damped by the pre-charge pressure of the working gas, which impinges on the inside of the bellows, as well as by the energy accumulator or the first compression spring between the underside of the bellows and the upper side of the poppet valve.

In the reverse case, i.e., when liquid flows out of the accumulator housing with a drop in pressure in the hydraulic circuit, the closing process of the poppet valve is supported by the internal pressure in the bellows and the first compression spring, the closing process being damped due to the spring action, in particular of the first compression spring between the valve device and the bellows and of the second compression spring of the poppet valve and, in the fully closed position of the valve device, a residual quantity of fluid remains as a supporting fluid between the outside of the bellows and the inside of the accumulator housing, which in this respect supports the bellows. In every operating situation, each individual fold of the bellows is surrounded by the liquid and is thus equally supported on all sides. In addition to operation that is low impact on the bellows, the bellows can then be subjected to extremely high, dynamically occurring pressure forces on both the gas side and the liquid side. Due the spring damping characteristic of the double-mass oscillator, it is additionally possible to operate the bellows accumulator in a very broad temperature range, for example from −55° C. to 100° C. and above, with only the wave spring providing temperature compensation.

In a particularly space-saving manner, it is beneficially provided that the valve device has a common connection for the supply and discharge of liquid that is at least partially penetrated by the valve device, which helps to prevent flow losses, for example due to the occurrence of turbulence.

In some embodiments, it is provided that the one and the further energy accumulator are each formed of a compression spring and that the spring stiffness of the one compression spring is greater than the spring stiffness of the other compression spring. Accordingly, the existing spring stiffness on the liquid side of the accumulator housing between the bellows and the valve device is greater than the spring stiffness of the compression spring on the poppet valve side, which results in improved spring/damper properties for the entire double-mass spring system.

It is for example also provided that, in the operating position of the accumulator, the one compression spring is arranged on the closure body of the bellows and the other compression spring is part of the valve device. Furthermore, it is beneficial that in this operating position, the one compression spring is supported, at least in the closed position of the poppet valve, with its one end on the upper side of the poppet valve and with its other end on the underside of the closure body of the bellows and the other compression spring is supported with its one end on the underside of the valve disc and with its other end on a holder for guiding the valve tappet of the poppet valve.

In some embodiments, it is further provided that the valve disc, in the closed position, is in contact with a sealing device, in particular in the form of an annular soft seal which is accommodated in a connection body of the accumulator housing, which connection body contains the valve device. In this way, it is ensured that due to the sealing device a sealing system is created which, when the bellows is expanded to its maximum possible expansion position, a residual quantity of liquid remains on the liquid side of the accumulator housing and in this way also enables the bellows to be supported for longer periods without having to worry that, due to leakage, the support liquid may reach the liquid side of the connected hydraulic circuit via the poppet valve which may not close completely tightly. In particular by using a soft seal, for example made of EPDM material, with the valve device closed, the residual quantity of liquid is securely enclosed even in the event of significant temperature changes during operation of the bellows accumulator.

In some embodiments, it is provided that the closure body is configured in the manner of a hemispherical shell which, in the possible, fully expanded state of the bellows, bounds a defined chamber volume for receiving liquid. The hemispherical shell, can also be replaced by a parabolic shell, the respective shell configuration ensuring that, as the expansion movement of the bellows increases, a counter-fluid force can be built up in the connection region to the valve device between the bellows to which the closure body belongs and the inner wall of the accumulator housing, which in this respect is correspondingly shell-shaped, which counter-fluid force is evenly distributed around the circumference of the closure body and in this manner visibly exerts a supporting force on the bellows together with the associated closure body due to displaced liquid. Particularly at low pressures, the supporting force can also be constant. This thus has no equivalent in prior art.

In some embodiments, it is provided that the lower bellows end is guided inside the accumulator housing by means of a ring-like guide body which, provided with fluid passages, establishes a permanent fluid connection between the one chamber volume in the region of the valve device and a further chamber volume which is substantially bounded by the inside of the accumulator housing and the outside of the bellows folds of the bellows. The fluid passages referred to ensure an even distribution of the individual quantities of liquid between the individual chamber volumes and thus an even support of the bellows over its entire installation space in the accumulator housing.

An embodiment of the bellows accumulator according to the invention is explained in greater detail below with reference to the drawings. Specific references to components, process steps, and other elements are not intended to be limiting. Further, it is understood that like parts bear the same or similar reference numerals when referring to alternate FIGS.

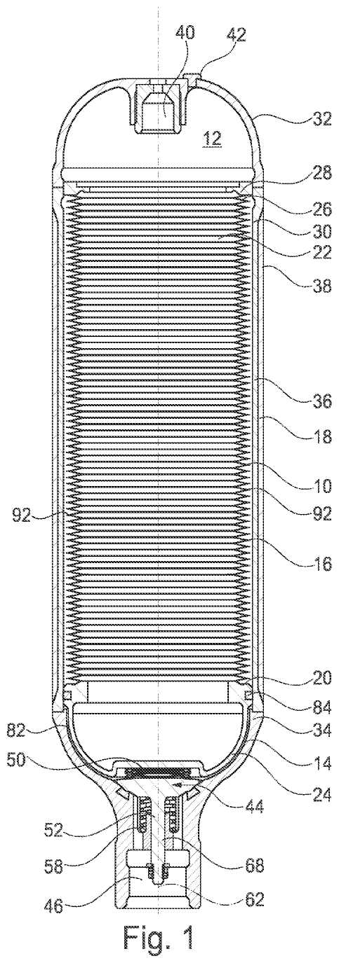

The bellows accumulator shown in FIG. 1 is a special representative of a hydraulic accumulator, in which a bellows 16, which serves as a movable separating element 10 between a first media side 12, in particular a gas side, and a second media side 14, in particular a liquid side, has, at its bellows end 20 which can move in an axial direction in an accumulator housing 18 during expansion and contraction, a closure body 24 which closes off the interior 22 of the bellows 16 in a media-tight manner. At its other bellows end 26, the bellows 16 is immovably fixed with respect to the accumulator housing 18. A retaining ring 28, which is welded in the usual way to the end of the bellows 16 and to the inside 30 of the accumulator housing 18, is used for this purpose. In this respect, the accumulator housing 18 consists of three individual housing parts which are connected to or welded to one another, the upper housing part 32 like the lower housing part 34 being dome-shaped and it being possible for a cylindrical housing part 36 arranged between them to be provided in the usual manner with a fibre winding 38 on the outer circumference for pressure stabilisation.

A compressible medium is introduced to the first media side 12, for example in the form of a working gas such as nitrogen gas that is under a predefinable pre-load or pre-charge pressure, which can now be significantly higher compared to otherwise conventional bellows accumulator solutions in prior art. A metal part 40 with glass insert in the manner of a sight glass opens if the internal pressure is too high. The accumulator can be filled with working gas, such as nitrogen gas, via a closure part 42 in the upper housing part 32. Furthermore, the bellows 16 is shown in FIG. 1 in its possible, most expanded position and when the bellows 16 is contracted, its associated travel movement is limited by the individual folds of the bellows 16 which then come into contact with each other. The bellows 16 is for example made of a stainless steel material which is media-resistant and pressure-stable and ensures that the working gas introduced to the media side 12 under the pre-charge pressure cannot transfer to the second media side 14 with the liquid. Corresponding bellows accumulators are routinely connected to hydraulic supply circuits (not shown) on their liquid side, so that hydraulic fluid from such a supply circuit is regularly present as liquid on the second media side 14.

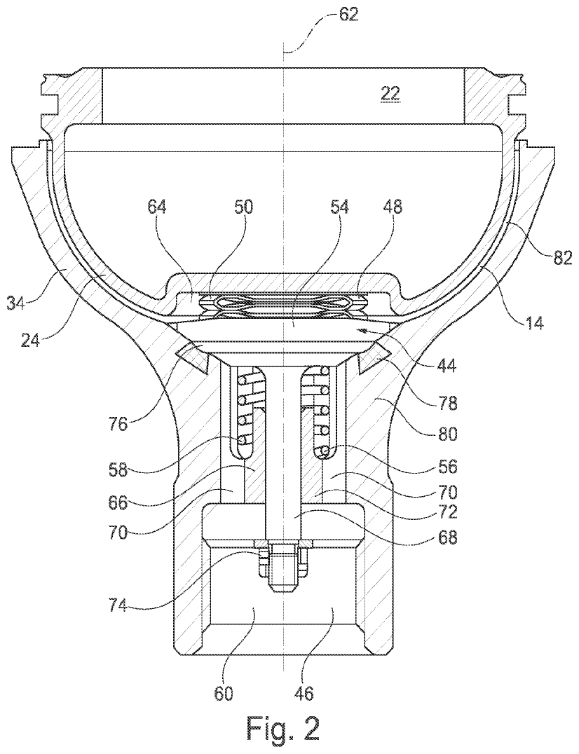

Furthermore, the bellows accumulator has a valve device denoted as a whole by 44, as shown in greater detail in FIG. 2. When the pressure on the liquid side 46 of the bellows accumulator drops, the valve device 44 moves to the closed position shown in FIG. 2 and in such a manner prevents any further outflow of liquid from the accumulator housing 18. In this respect, the closing movement is supported by means of at least one energy accumulator 48, which is arranged between the valve device 14 and the closure body 24 of the bellows 16 and which controls the closing process for the valve device 14 in such a manner that in each case a predefinable quantity of liquid still remains in the accumulator housing 18 on its second media side 12, the corresponding quantity of liquid supporting the bellows 16 in its expanded position with its individual folds as shown in FIG. 1. The energy accumulator 48 can be formed from a conventional compression spring 50, for example in the form of a disc spring or disc spring assembly.

As FIG. 2 shows in particular, the valve device 44 comprises a poppet valve 52, the valve disc 54 of which is held or pressed in the direction of its open position, allowing liquid through, counter to the action of a further energy accumulator 56, routinely in the form of a spiral compression spring 58, and, when actuated accordingly, moves into its closed position shown in FIG. 2, blocking the passage of liquid.

The valve device 44 has a common connection 60 for the supply and discharge of liquid, one end of which as a through-opening opens out onto the second media side 14 and the other opposing end of which is connected to the hydraulic circuit that is not shown in greater detail. Instead of the hydraulic circuit referred to, the bellows accumulator can also be connected to other hydraulic components, such a hydraulic working cylinder, which appropriately has to be supplied with fluid under pressure for it to work.

In any case, the spring stiffness of the compression spring 50 is selected to be greater than the spring stiffness of the valve spring 58. As further emerges from FIG. 2, the one compression spring 50 is arranged on the closure body 24 of the bellows 16 and the other compression spring 58 is part of the valve device 44. To accommodate the compression spring 50, the dome-shaped closure body 24 is provided on the outside with a cylindrical recess 64 concentric with the longitudinal axis 62 of the bellows accumulator. In this respect, the compression spring 50 is supported with its one upper free end on the recess 64 and with its other free lower end on the upper side of the valve disc 54. In contrast, the other second compression spring 58 is supported with its one upper free end on the underside of the valve disc 54 and with its other free lower end on a holder 66 for longitudinal guidance of the valve tappet 68 of the poppet valve 52. For this purpose, the fluid connection 60 is configured to be solid on the wall side and is provided with individual longitudinal drilled holes 70 (4 to 8 in total) which, concentric with the longitudinal axis 62 of the accumulator, leave a central guide 72 through which the valve tappet 68 passes. Furthermore, in the usual manner the valve tappet 68 has a stop limiter 74 on its underside which, in the uppermost travel position of the valve disc 54, comes into abutment with the lower edge limiter of the central guide 72 as part of the valve holder 66. In this respect, the second compression spring 58 is thus supported with its upper free end on the underside of the valve disc 54 and with its opposing lower end on a shoulder-like protrusion of the holder 66 or central guide 72.

In the closed position of the poppet valve 52 shown in FIG. 2, the valve disc 54 rests with its underside on a sealing device 78 via a centrally arranged, outwardly projecting annular sealing protrusion 76, in the manner of a sealing bead, which sealing device is formed in particular from an annular soft seal (EPDM) which is accommodated in a connection body 80 of the accumulator housing 18, which connection body contains the valve device 44 and outwardly bounds the fluid connection 60. In this respect, the connection body 80 is an integral part of the lower housing part 34.

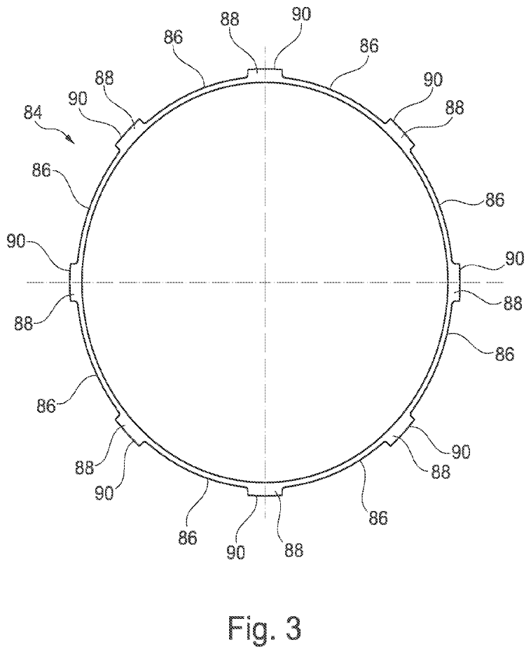

As further emerges from FIGS. 1 and 2, the closure body 24 is formed in the manner of a hemispherical shell which, in the possible, fully expanded state of the bellows 16, bounds a defined chamber volume 82 for receiving liquid. In this respect, as shown in particular in FIG. 2, the inner circumferential side of the lower housing part 34 is configured to follow the dome shape of the closure body 24, so that, in the closed position of the valve device 44 shown, the wall distance between the closure body 24 and the lower housing part 34 is constant, provided that they are adjacent to and opposite each other as shown. If the bellows 16 lifts upwards, viewed in the direction of FIGS. 1 and 2, the corresponding chamber volume 82 increases under the action of the fluid pressure which flows in from the fluid connection 60 to the second media side 14 of the accumulator housing 18 when the valve device 44 is open. The bellows accumulator also has a ring-like guide body 84, which has been omitted in FIG. 2 for easier illustration and which is shown in a view from above in FIG. 3. This guide body 84 guides the lower bellows end 20 inside the accumulator housing 18 in the operating position of the bellows accumulator, as shown in FIGS. 1 and 2, and the ring-like guide body 84 has individual segment-like recesses 86 which are separated from one other at equal radial distances by radial protrusions 88. The outer circumferential side 90 of the protrusions 88, which project outwards in the same way, form guide surfaces for contact with the inner side 30 of the accumulator housing 18. The segment-like recesses 86, on the other hand, enable a fluid connection between the said first chamber volume 82 and a further second chamber volume 92 above the guide body 84. In this way, the supporting fluid can be exchanged in both directions between the chamber volumes 82 and 92 via the recesses 86 in a pressurised manner, so that the individual folds of the bellows 16 are surrounded by the supporting liquid in every operating state.

As the closure body 24 is dome-shaped, in this respect there is also storage space for the working gas on its inside, so that in this respect the working capacity of the bellows accumulator is improved by increased accommodation of gas. The guide body 84 also prevents unintentional buckling along the fold structure of the bellows 16. Overall, an accumulator solution is created which can be operated with high pre-charge pressures on the gas side and overall high operating pressures, and without failure, since the bellows 16 can be fully supported along its outer circumference on the liquid side even when the valve device 44 is closed, which also applies in the event that the accumulator is almost emptied of liquid and only a residual quantity of fluid, as described above, remains between the outside of the bellows 16 and the inner circumferential side of the accumulator housing 18 when the valve device 44 is closed. This thus has no equivalent in prior art.

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfil the functions of several items recited in the claims.

The term “exemplary” used throughout the specification means “serving as an example, instance, or exemplification” and does not mean “preferred” or “having advantages” over other embodiments. The term “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1-9. (canceled)

10. A bellows accumulator, in which a bellows, which serves as a movable separating element between a first media side and a second media side, has, at a bellows end which can move in an axial direction in an accumulator housing during expansion and contraction, a closure body which closes off an interior of the bellows in a media-tight manner and, at an other bellows end, is immovably fixed with respect to the accumulator housing, and having a valve device which, when the pressure on the second media side drops, moves to a closed position, thereby preventing liquid from continuing to flow out of the accumulator housing, wherein the closing process for the valve device is controlled using at least one energy accumulator, which is arranged between the valve device and the closure body of the bellows, in such a way that a predefinable quantity of liquid remains in the accumulator housing in any case, said quantity of liquid supporting the bellows in its expanded position.

11. The bellows accumulator of claim 10, wherein the valve device has a poppet valve, a valve disc of which is held in its open position, allowing liquid through, counter to the action of a further energy accumulator and, when actuated, moves into its closed position, blocking the passage of liquid.

12. The bellows accumulator of claim 10, wherein the valve device has a common connection for the supply and discharge of liquid, which is at least partially penetrated by the valve device.

13. The bellows accumulator of claim 10, wherein the one and the further energy accumulator are each formed of a compression spring, and wherein the spring stiffness of the one compression spring is greater than the spring stiffness of the other compression spring.

14. The bellows accumulator of claim 13, wherein the one compression spring is arranged on the closure body of the bellows and the other compression spring is part of the valve device.

15. The bellows accumulator of claim 13, wherein, in the operating position, the one compression spring is supported with its one end on the upper side of the poppet valve and with its other end on the underside of the closure body of the bellows and the other compression spring is supported with its one end on the underside of the valve disc and with its other end on a holder for guiding the valve tappet of the poppet valve.

16. The bellows accumulator of claim 11, wherein the valve disc, in the closed position, is in contact with a sealing device, in particular in the form of an annular soft seal, which is accommodated in a connection body of the accumulator housing, which connection body contains the valve device.

17. The bellows accumulator of claim 10, wherein the closure body is configured in the manner of a hemispherical shell which, in the fully expanded state of the bellows, bounds a defined chamber volume for receiving liquid.

18. The bellows accumulator of claim 10, wherein the lower bellows end is guided inside the accumulator housing by means of a ring-like guide body which, provided with fluid passages, establishes a permanent fluid connection between the chamber volume in the region of the valve device and a further chamber volume which is substantially bounded by the inside of the accumulator housing and the outside of the bellows folds of the bellows.

19. The bellows accumulator of claim 10, wherein the first media side is a gas side.

20. The bellows accumulator of claim 10, wherein the second media side is a liquid side.

21. The bellows accumulator of claim 11, wherein the valve device has a common connection for the supply and discharge of liquid, which is at least partially penetrated by the valve device.

22. The bellows accumulator of claim 11, wherein the one and the further energy accumulator are each formed of a compression spring, and wherein the spring stiffness of the one compression spring is greater than the spring stiffness of the other compression spring.

23. The bellows accumulator of claim 12, wherein the one and the further energy accumulator are each formed of a compression spring, and wherein the spring stiffness of the one compression spring is greater than the spring stiffness of the other compression spring.

24. The bellows accumulator of claim 14, wherein, in the operating position, the one compression spring is supported with its one end on the upper side of the poppet valve and with its other end on the underside of the closure body of the bellows and the other compression spring is supported with its one end on the underside of the valve disc and with its other end on a holder for guiding the valve tappet of the poppet valve.

25. The bellows accumulator of claim 21, wherein the valve disc, in the closed position, is in contact with a sealing device, in particular in the form of an annular soft seal, which is accommodated in a connection body of the accumulator housing, which connection body contains the valve device.

26. The bellows accumulator of claim 22, wherein the valve disc, in the closed position, is in contact with a sealing device, in particular in the form of an annular soft seal, which is accommodated in a connection body of the accumulator housing, which connection body contains the valve device.

27. The bellows accumulator of claim 11, wherein the closure body is configured in the manner of a hemispherical shell which, in the fully expanded state of the bellows, bounds a defined chamber volume for receiving liquid.

28. The bellows accumulator of claim 12, wherein the closure body is configured in the manner of a hemispherical shell which, in the fully expanded state of the bellows, bounds a defined chamber volume for receiving liquid.

29. The bellows accumulator of claim 13, wherein the closure body is configured in the manner of a hemispherical shell which, in the fully expanded state of the bellows, bounds a defined chamber volume for receiving liquid.
